(19) United States
(12) Patent Application Publication
(10) Pub. No.: US 2008/0127881 A1
(43) Pub. Date: Jun. 5, 2008

(54) Accessory For A Golf Flag-Stick

(75) Inventors: Darryl Stegmann, Kyalami Estate (ZA); Nicolaas Willem Pretorius, Bloemfontein (ZA); Andrew Julian Tyndale-Biscoe, Johannesburg (ZA)

Correspondence Address: SHERIDAN ROSS PC, 1560 BROADWAY, SUITE 1200, DENVER, CO, 80202, US

(73) Assignee: SAXON TRUST, JOHANNESBURG (ZA)

(21) Appl. No.: 11/719,007

(22) PCT Filed: Nov. 11, 2005
(86) PCT No.: PCT/IB05/03365

§ 371 Date: May 10, 2007

(30) Foreign Application Priority Data
Nov. 10, 2004 (ZA) 2004/9108
Dec. 20, 2004 (ZA) 2004/10243
Jun. 17, 2005 (ZA) 2005/04950

(51) Int. Cl. G09F 17/00; G09F 25/00

(52) U.S. Cl. 116/173; 340/286.01

(57) ABSTRACT

A golf hole marker assembly 10 includes a pole 12 on which a display member 30 is mounted. A cover 32 is mounted over the display member 30 so that matter displayed on the display member 30 is visible through the cover 32. A lower end of the pole 12 is receivable in a cup countersunk into a hole in the ground. An operatively lower end of the cover is spaced longitudinally from the lower end of the pole a sufficient distance so as not to interfere with a golf ball rolling into the hole. The invention extends to an accessory which includes a display member 30 and cover 32 which are mountable on a pole 12.

THIS INVENTION relates to golf. More particularly it relates to an accessory for a hole marker. It further relates to a golf hole marker assembly. It also relates to a display member and to a display unit. In addition it relates to a golf hole marker and to a golf hole marker assembly kit.

In golf, use is made of hole markers to indicate the position of a hole. These hole markers typically include a pole having a lower end which is removably receivable in a cup countersunk into a hole in the ground. Where intended for use on the golf course the poles are relatively long, typically 2 m or more and usually have a flag attached to the upper end thereof. When intended for use on a practice putting or chipping green the poles tend to be shorter and instead of a flag may have a handle or hole number attached to the upper end thereof.

According to one aspect of the invention there is provided an accessory for a hole marker which accessory includes a cover for covering at least part of at least one display member, at least part of the cover being transparent such that matter appearing on said at least one display member is visible through the cover, the cover being mountable on a pole of a hole marker.

The accessory may include fixing means for fixing the cover to a pole of a hole marker.

The cover may be receivable over a pole of a hole marker, the fixing means being configured to fix the cover to the pole such that at least a lower end portion of the pole protrudes from the cover.

Preferably, the fixing means is configured to fix the cover to the pole in a manner which permits replacement of a said at least one display member. Preferably, the fixing means fixes the cover releasably to the pole.

The cover may be in the form of a tube formed of a transparent synthetic plastics material, e.g. polycarbonate, the fixing means including at least one collar which is mounted or mountable on the pole to support the cover.

The fixing means may include two collars mountable on the pole at longitudinally spaced apart positions to support opposed ends of the cover, each collar having a centrally disposed hole therethrough through which a part of the pole is receivable and being lockable to the pole by one or more locking screws.

The or each collar may be configured such that a portion thereof is snugly receivable in an end of the cover, the accessory including seal means for providing a seal between the or each collar and the cover and/or the pole.

The accessory may include at least one display member which defines at least one display surface which can be covered by and is visible through the cover.

The display member may be in the form of a sleeve receivable inside the cover and over the pole of a hole marker. Hence, the cover and the fixing means together form retaining means for retaining the sleeve in position on the pole.

According to another aspect of the invention there is provided an accessory for a hole marker which includes a display member which defines at least one display surface on which matter to be displayed is receivable, the display member being removably mountable on a pole of a hole marker.

The accessory may include retaining means for retaining the sleeve releasably in position on the pole.

The display means may be in the form of a sleeve which is receivable over a pole of a hole marker such that at least a lower end portion of the pole protrudes from the sleeve.

The sleeve may be tubular and may be formed of a synthetic plastics material.

The sleeve may be circular in transverse cross-section.

Instead, the sleeve may include a plurality of angularly spaced planar display surfaces. In one embodiment of the invention, the sleeve may be triangular in transverse cross-section and have three angularly spaced rectangular display surfaces.

The accessory may have a length of at least 500 mm. In order to avoid excessive wind loading, the accessory may have a width of not greater than 10 cm. Preferably, in order to facilitate handling of the accessory and a hole marker on which it is mounted, the accessory has a width of not greater than 51 mm.

According to a further aspect of the invention there is provided a golf hole marker assembly which includes:

a pole having a lower end which is removably receivable in a cup countersunk into a hole in the ground; and

a display member dismountably mounted on the pole and defining at least one outwardly directed display surface.

The golf hole marker assembly may include a cover, at least part of which is transparent, covering the display member such that the display surface or matter displayed thereon is visible through the cover.

It will be appreciated that in use, i.e. when the lower end of the flag-pole is positioned in a cup a lower end portion of the flag-pole will be positioned below the level of the ground. The display member is preferably spaced longitudinally from the lower end portion of the flag-pole which is below the level of the ground when the flag-stick is positioned in a said cup.

The invention extends to a golf hole marker assembly which includes:

a pole having a lower end which is removably receivable in a cup countersunk into a hole in the ground; and

an accessory for a hole marker as described above mounted on the pole.

A lower end of the accessory may be spaced longitudinally from the lower end of the pole by a distance which is greater than B, where B is the length of the pole which will be below the surface of the ground when the pole is positioned in a said cup.

The display member may be spaced longitudinally from the lower end of the pole by a distance of at least B+30 mm, so that the accessory will not interfere with a ball rolling into the hole when the lower end of the pole is positioned therein. Preferably, the display member will be spaced longitudinally from a lower end of the pole by a distance of at least B+610 mm.

The invention further extends to a golf hole marker assembly which includes

an elongate lower end portion having an operatively lower end and an operatively upper end; and

an elongate adjacent portion disconnectably connected to the operatively upper end of the lower end portion, the adjacent portion having, for at least part of its length transverse dimensions which are greater than those of the lower end portion and defining at least one outwardly directed display surface, the lower end portion being sufficiently long so that when a lower end of the golf hole marker assembly is positioned in a cup countersunk into the hole in the ground, an operatively lower end of the adjacent portion is spaced above the surface of the ground.

In one embodiment of the invention the adjacent portion is circular in cross-section.

In another embodiment of the invention, the adjacent portion is multi-facetted having a plurality of elongate rectangular angularly spaced display surfaces.

The golf hole marker assembly may include an upper portion which is connected to and protrudes from an operatively upper end of the adjacent portion.

In one embodiment of the invention, the upper portion may include flag mounting means whereby a flag is mountable thereon.

In another embodiment of the invention, the upper portion may be in the form of a handle to facilitate removal of the golf hole marker assembly from a hole.

The invention further extends to a golf hole marker assembly which includes

a display member defining at least one display surface; and

a cover, at least part of which is transparent, covering at least part of the display member such that the display surface or matter displayed thereon is visible through the cover.

The display member may be mounted on a pole a lower end of which is removably receivable in a cup countersunk into a hole in the ground, the cover being tubular and having a lower end which is spaced longitudinally from the lower end of the pole.

The invention extends still further to a golf hole marker assembly which includes

a pole having a lower end which is removably receivable in a cup countersunk into a hole in the ground; and

a rigid display member mounted on the pole and defining at least one outwardly directed display surface on which matter to be displayed is provided or is receivable.

The rigidity of the display member will be such that the rebound properties of a golf ball striking the display member would be similar to those of a golf ball striking a pole of a conventional hole marker so that a golfer will be neither advantaged nor disadvantaged by the presence of the display member.

Further, the invention extends to a golf hole marker assembly which includes

a pole having a lower end which is removably receivable in a cup countersunk into a hole in the ground; and

a display member defining at least one display surface and having a lower end which is spaced from the lower end of the pole so that when the lower end of the pole is positioned in the cup, the lower end of the display member is positioned above the surface of the ground, the display member having a length of at least 0.5 m.

The display member preferably has a length of at least 1 m.

The invention further provides a golf hole marker assembly which includes

a pole having a lower end which is releasably receivable in a cup countersunk into a hole in the ground; and

a display member defining at least one display surface and having a lower end which is spaced from the lower end of the pole so that when the lower end of the pole is positioned in the cup the lower end of the display member is positioned above the surface of the ground, the display member having a width of not greater than 100 mm.

Preferably, the display member has a width of not greater than 51 mm.

The invention extends further to a golf hole marker assembly which includes

a pole having a lower end which is removably receivable in a cup countersunk into a hole in the ground; and

a display member which is secured adhesively to the pole.

The display member may be in the form of a sticker.

The invention extends to a golf hole marker assembly which includes

a pole having a lower end which is removably receivable in a cup countersunk into a hole in the ground; and

a display member mounted on the pole and having a length which is equal to or greater than 35% of the length of the pole.

The display member may have a length which is equal to or greater than 40% of the length of the pole.

The display member may have a length which is equal to or greater than 50% of the length of the pole.

The display member may have a length which is equal to or greater than 60% of the length of the pole.

The display member may have a length which is equal to or greater than 75% of the length of the pole.

The hole marker assembly may include a cover, at least part of which is transparent, covering at least part of the display member.

The invention further extends to a golf hole marker which includes

a pole having a lower end which is removably receivable in a cup countersunk into a hole in the ground; and

fixing means for mounting a display member on the pole.

The invention extends to a display member for an accessory as described above.

It further extends to a display member for a golf hole marker assembly as described above.

The invention extends further to a display member for mounting on a golf hole marker, the display member comprising a sleeve having at least one outwardly projecting display surface on which matter to be displayed is provided.

The invention extends still further to a display unit comprising a display member and a cylindrical cover, the display member defining at least one outwardly projecting display surface on which matter to be displayed is provided; wherein at least part of the cover is transparent and the display member is provided inside the cover.

The invention also extends to a golf hole marker assembly kit which includes

a pole having a lower end which is removably receivable in a cup countersunk into a hole in the ground; and

a display member defining at least one display surface which is mountable on the pole.

The kit may include a cover mounted or mountable over at least part of the display surface.

According to another aspect of the invention there is provided an accessory for a golf flag-stick which includes

a sleeve which is receivable over a flag-pole of a flag-stick such that at least a lower end portion of the flag-pole protrudes from an end of the sleeve, the sleeve having at least one outwardly directed display surface; and

retaining means for retaining the sleeve in position on the flag-pole,

Preferably, the sleeve is receivable over the flag-pole such that upper and lower end portions of the flag-pole protrude from opposed ends of the sleeve.

The retaining means is preferably configured such that the sleeve is retained releasably in position on the flag-pole thereby enabling the sleeve to be removed and, if desired, replaced with a different sleeve.

The retaining means may include a cover which is receivable over the sleeve and is configured so that the display surface or matter displayed thereon is visible through the cover, and fixing means for fixing the cover, preferably releasably, to the flag-pole.

The cover may be in the form of a tube formed of a transparent synthetic plastics material. The fixing means may include at least one collar which is mountable on the flag-pole to support the cover.

Preferably, the fixing means includes two collars mountable on the flag-pole at longitudinally spaced apart positions to support opposed ends of the cover. The or each collar may have a centrally disposed hole therethrough through which a part of a flag-pole is receivable, the collar being lockable to the flag-pole by one or more locking screws.

The or each collar may be configured such that a portion thereof is snugly receivable in an end of the cover.

The accessory may include seal means for providing a seal between the or each collar and cover and/or the flag-pole.

The sleeve may include a plurality of angularly spaced planar display surfaces. In a preferred embodiment of the invention, the sleeve is triangular in cross-section having three rectangular display surfaces.

According to another aspect of the invention there is provided a golf flag-stick assembly which includes

a flag-pole having a lower end which is removably receivable in a cup countersunk into a hole in the ground;

a display member mounted on the flag-stick, the display member defining at least one outwardly directed display surface and being spaced from the lower end of the flag-stick such that when the flag-stick is positioned in a said cup, the display member is positioned above the level of the ground.

It will be appreciated that in use, i.e. when the lower end of the flag-pole is positioned in a cup a lower end portion of the flag-pole will be positioned below the level of the ground. The display member is preferably spaced longitudinally from the lower end portion of the flag-pole which is below the level of the ground when the flag-stick is positioned in a said cup.

Preferably, the display member is spaced a distance of at least 0.6 m from the lower end portion of the flag-stick.

The display member may be spaced a distance of at least 0.3 m from the lower end portion of the flag-stick.

In other words, when the flag-stick is positioned in a said cup, the lower end of the display member will be spaced above the surface of the ground by a distance of at least 0.6 m.

According to a further aspect of the invention there is provided a golf flag-pole which includes

a lower end portion having an operatively lower end and an operatively upper end; and

an adjacent portion connected to the operatively upper end of the lower end portion, the adjacent portion having, for at least part of its length, lateral dimensions which are greater than those of the lower end portion and defining at least one outwardly directed display surface, the lower end portion being sufficiently long so that when a lower end of the flag-pole is positioned in a cup countersunk into a hole in the ground, an operatively lower end of the adjacent portion is spaced above the surface of the ground.

The length of the lower end portion will typically be selected so that the operatively lower end of the adjacent portion will, in use, be spaced above the surface of the ground by a distance of at least 0.3 m. Preferably, the operatively lower end of the adjacent portion will be spaced above the ground a distance of at least 0.6 m.

The adjacent portion may be circular in cross-section. The diameter of the adjacent portion may be not greater than 60 mm. Preferably, the diameter of the adjacent portion is 50 mm. The diameter of the adjacent portion may be not less than 25 mm.

In another embodiment of the invention, the adjacent portion may be multi-facetted having a plurality of elongate rectangular angularly spaced display surfaces.

The adjacent portion may be disconnectably connected to the lower end portion. Hence, when it is desired to change the matter which is displayed on the display surface or surfaces, the adjacent portion can be removed and replaced with an adjacent portion on which the new matter to be displayed appears.

The flag-pole typically includes flag mounting means whereby a flag is mountable thereon. The flag mounting means may include an upper portion which is connected to and protrudes from an operatively upper end of the adjacent portion and which has lateral dimensions which are less than those of adjacent portion.

The flag-pole may have matter displayed on the display surface.

According to another aspect of the invention there is provided a golf flag-pole having a lower end which is removably receivable in a hole in a cup countersunk into a hole in the ground and an outwardly directed display surface spaced from the lower end of the flag-pole.

According to yet another aspect of the invention there is provided a golf flag-stick which includes

a flag-pole of the type described above; and

a flag mounted on the flag-pole.

The invention will now be described, by way of example, with reference to the accompanying diagrammatic drawings.

In the drawings:

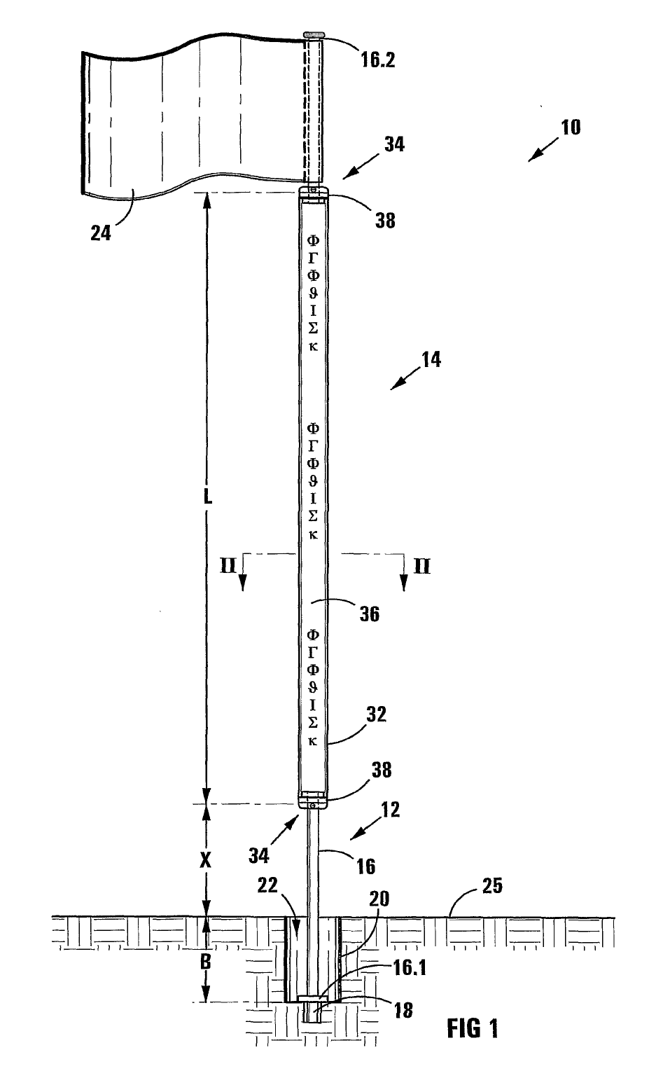

FIG. 1 shows a side view of a golf hole marker assembly in accordance with the invention;

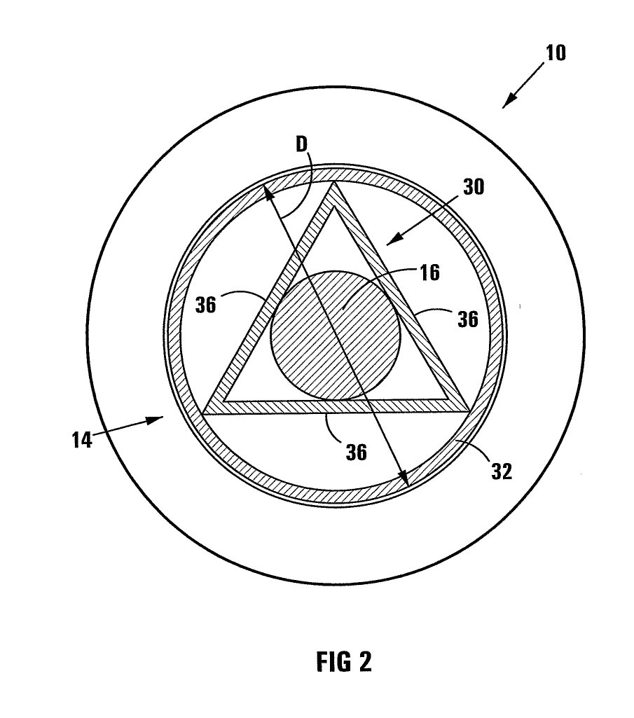

FIG. 2 shows a sectional elevation taken at II-II in FIG. 1;

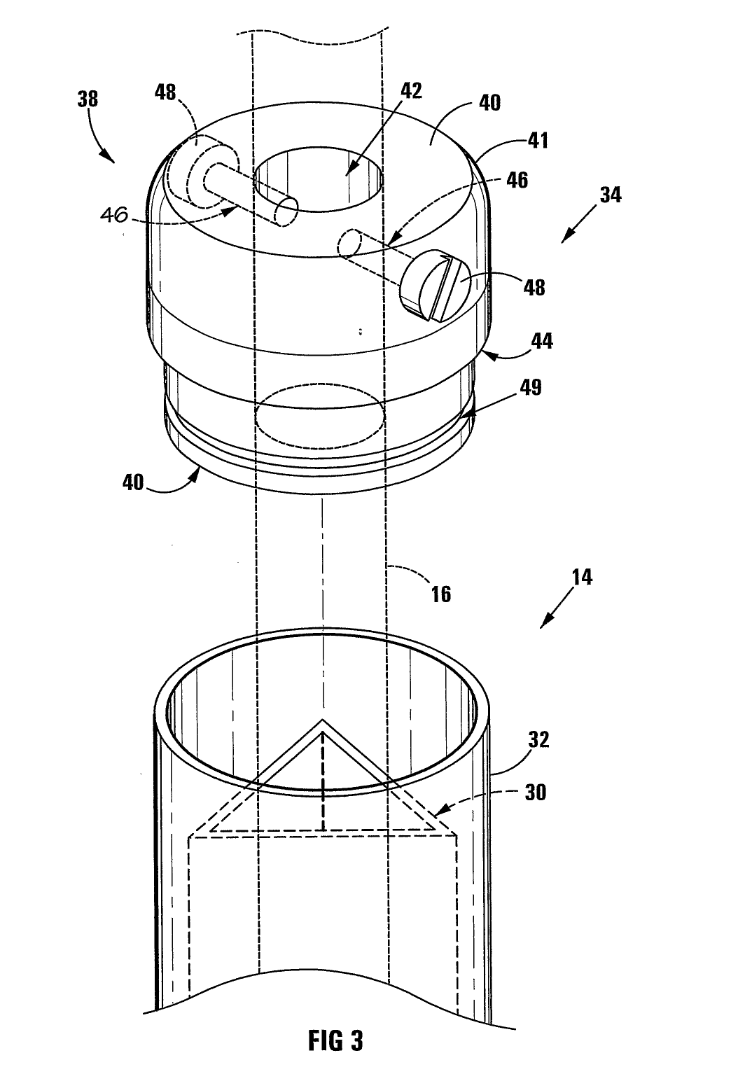

FIG. 3 shows a three-dimensional exploded view of part of the assembly of FIGS. 1 and 2;

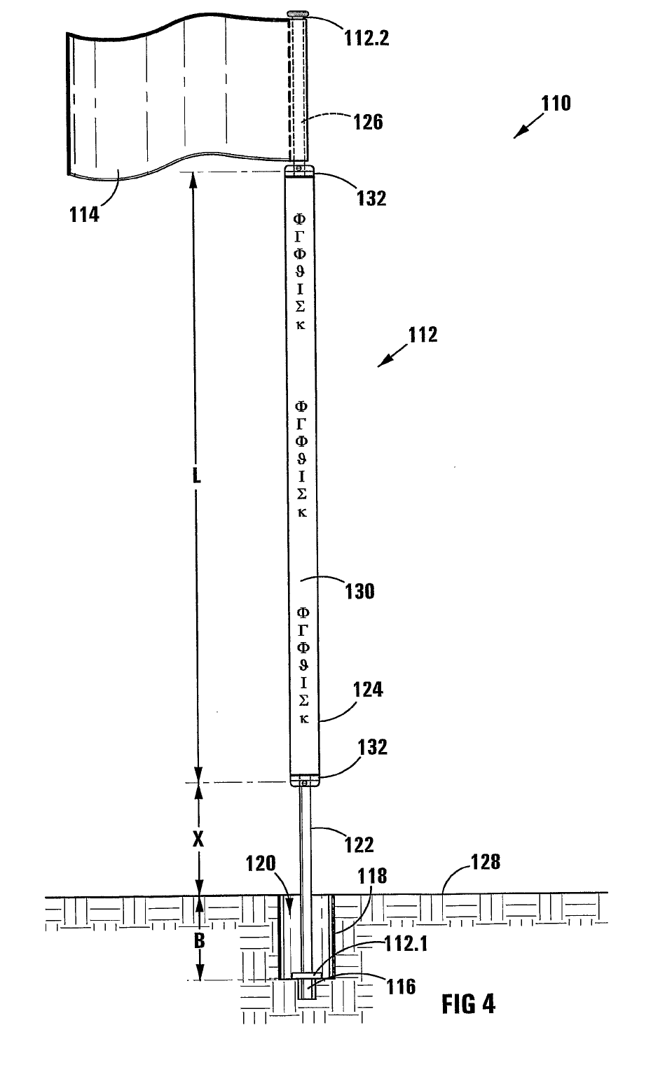

FIG. 4 shows a side view of another golf hole marker assembly in accordance with the invention;

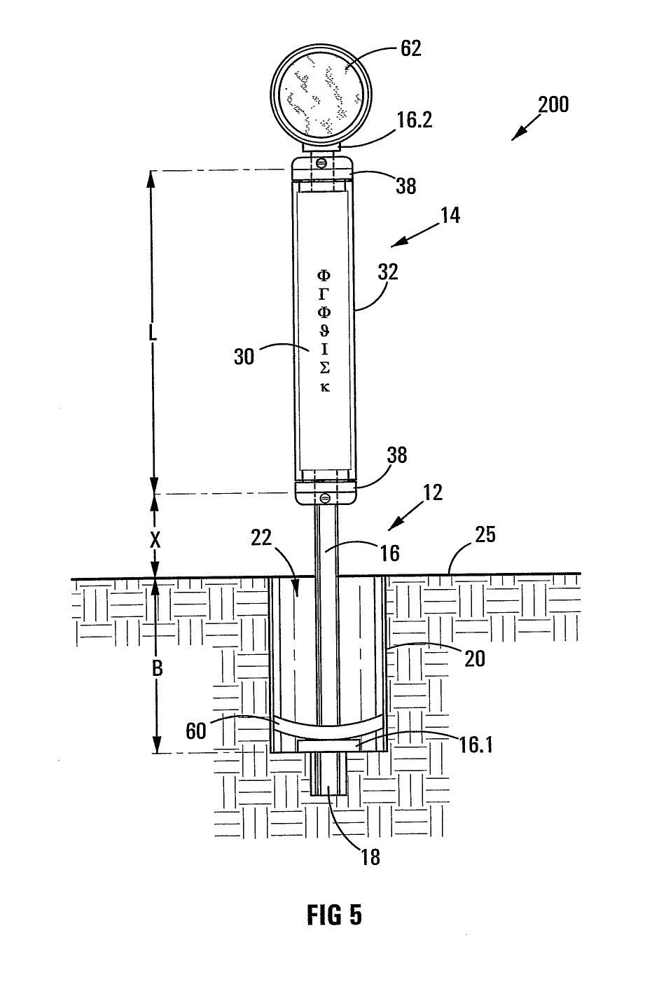

FIG. 5 shows a side view of yet another hole marker assembly in accordance with the invention;

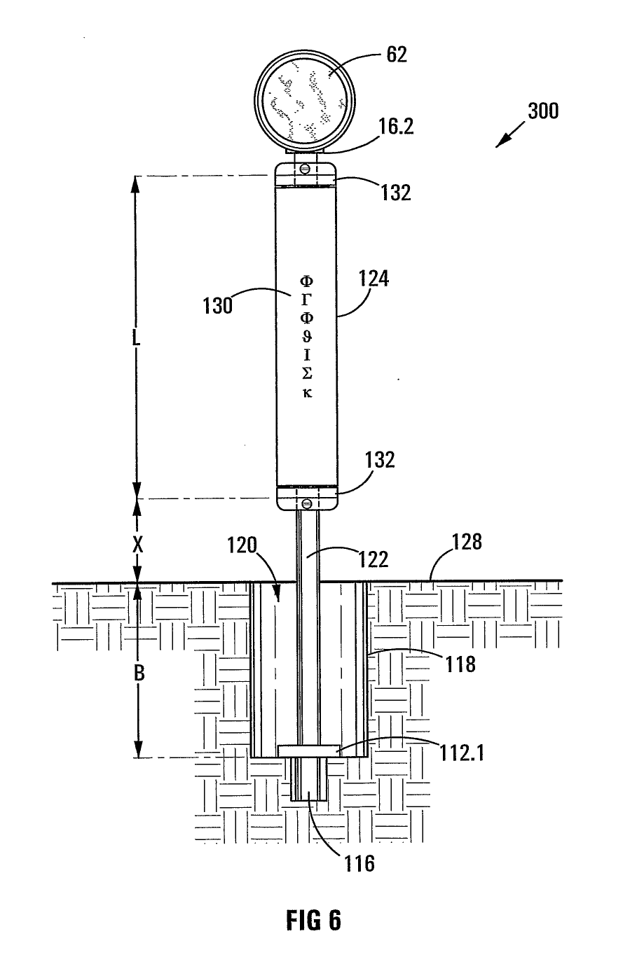

FIG. 6 shows a side view of still another golf hole marker assembly in accordance with the invention; and

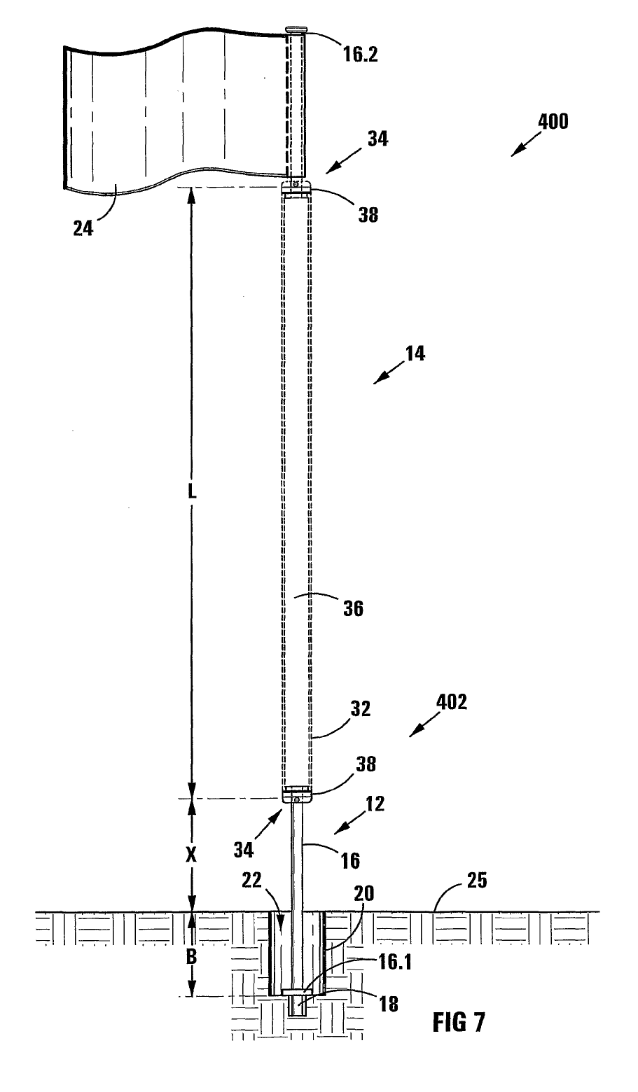

FIG. 7 shows a side view of a golf hole marker in accordance with the invention.

In FIGS. 1 to 3 of the drawings, reference numeral 10 refers generally to a golf hole marker assembly in accordance with the invention. The assembly 10 includes a pole in the form of a golf flag-stick, generally indicated by reference numeral 12, and an accessory for a hole marker in accordance with the invention, generally indicated by reference numeral 14, mounted on the flag stick 12.

The flag-stick 12 is of conventional construction comprising a flag-pole 16 having an operatively lower end 16.1 and operatively upper end 16.2. A ferrule 18 is mounted on the lower end of the flag-pole 16 and is receivable in a complementary socket in a cup 20 which is countersunk in a hole 22 in the ground, typically in a green, such that the flag-pole 16 extends vertically upwardly therefrom. The flag-stick 12 further includes a flag 24 mounted on an upper end portion of the flag-pole 16 in a conventional fashion.

As can best be seen in FIG. 1 of the drawings, when the ferrule 18 is positioned in the complementary socket in the cup 20 a lower end portion B of the flag-pole 16 is positioned below the surface 25 of the green. The length of the lower end portion B naturally depends on the depth to which the cup 20 is countersunk into the hole 22 and may accordingly vary.

The accessory 14 includes a display member in the form of a tubular sleeve 30 which is receivable, with clearance, over the flag-pole 16, a tubular cover 32 which is receivable over the sleeve 30 and retaining means, generally indicated by reference numeral 34 for retaining the accessory 14 at a desired position on the flag-pole 16.

In the embodiment shown, the sleeve 30 is generally triangular in transverse cross-section having three elongate rectangular angularly spaced display surfaces 36. Naturally, the shape of the display member 30 and hence the particular configuration of the display surface or surfaces can vary, e.g. the display member could be square, circular or any other suitable cross-section. Further, instead of being of rigid tubular form, the display member may be formed of sheet material, e.g. paper, cardboard or a synthetic plastics material such as vinyl which is deformable and receivable within and takes the shape of the cover 32. Instead, the display member could be in the form of a sticker which is applied directly to the surface of the flag-pole 16.

The cover 32 is formed of a transparent synthetic plastics material such as polycarbonate or Perspex which is sufficiently strong to withstand impact from a golf ball. Further, the cover can be designed to have the desired rebound properties so that the energy of a golf ball coming into contact with the cover is not simply absorbed thereby ensuring that a golfer whose ball comes into contact with the cover is neither advantaged nor disadvantaged by its presence. If desired the material of the cover may be treated to render it resistant to the elements and in particular to render it U.V. resistant.

The fixing means 34 includes a pair of substantially identical collars 38. As can best be seen in FIG. 3 of the drawings, each collar 38 has a circular inner end 40, an outer end 41 and an axially extending bore 42 extending through the collar and opening out of the ends 40, 41. In the embodiment shown the outer end 41 is domed, however, it may take any suitable form. The bore 42 is dimensioned such that the collar 38 is slidingly receivable over the flag-pole 16 with little clearance. Each collar 38 is provided with an annular outwardly protruding shoulder 44 intermediate its ends 40, 41. The collars 38 are dimensioned such that inner end portions thereof are snugly receivable in the ends of the cover 32, the shoulders 44 functioning as stops to limit the depth to which the collars 38 can be inserted into the cover 32. Each collar 38 includes a plurality of circumferentially spaced threaded holes 46 extending radially outwardly from the bore 42. The collars 38 are releasably lockable to the flag-pole 36 by means of locking screws 48 screwed into the holes 46 and into engagement with the flag-pole 16. Instead of making use of the screws 48, the collars 38 can be retained in position by friction, e.g. by being a tight fit on the flag-pole 36 or in any suitable fashion.

In order to assemble the hole marker assembly 10, the flag 24 is removed from the flag-pole 16. The lower collar 38 is positioned over the flag-pole and secured in position on the flag-pole 16 by means of locking screws 48. The sleeve 30 which has matter to be displayed, e.g. advertising matter, such as logos, company names, brand names and/or slogans, on the display surfaces 36 is then positioned over the flag-pole 16 such that a lower end thereof rests on the lower collar 38. The cover 32 is then positioned over the sleeve 30 and over the collar 38 until it abuts against the shoulder 44. The upper collar 38 is then positioned over the flag-pole and inserted into an upper end of the cover 32 until the shoulder 44 of the collar 38 abuts against the upper edge of the cover 32. The upper collar 38 is then secured in position by locking screws 48. Hence, the cover 32 is held captive between the collars 38 and the matter displayed on the sleeve 30 is visible through the cover 32. The flag 24 is then mounted on the flag-pole 16, permitting the assembly 10 to be used in the same manner as a conventional flag-stick.

Instead, after securing the lower collar 38 on the flag-pole 16, the cover 32 is positioned over the flag-pole 16 such that a lower end thereof rests on the lower collar 38. The display member 30 is inserted into the annular space between the flag-pole 16 and the cover 32 through the open top of the cover 32. The upper collar 38 is then secured in position in the manner described above.

If desired, seals, e.g. in the form of O-rings (not shown) may be provided on radially inner and outer annular recesses 49 (one of which is shown in FIG. 3) on the collars 38 in order to seal against the flag-pole 16 and the cover 32 so as to inhibit the ingress of moisture into the interior of the cover 32.

In order to avoid possibly interfering with a ball rolling into the hole 22, the lower end of the accessory 14 is positioned above the lower end portion B by a distance X. The distance X will typically be at least 30 mm which would be suitable for a practice putting green. On a golf course the distance X will more likely will be of the order of 0.6 m.

It will be appreciated, that the dimensions of the accessory 14 can vary. However, the Inventor believes that an accessory having a length L of about 1.4 m with the cover 32 having a diameter D of about 50 mm will work satisfactorily. Further the Inventor has confirmed that an accessory in accordance with the invention will comply with the rules of the USGA and the R&A.

Reference is now made to FIG. 7 of the drawings, in which reference numeral 400 refers generally to a golf hole marker in accordance with the invention. Unless otherwise indicated, the same reference numeral used above are used to designate similar parts. The golf hole marker 400 includes a flag-stick 12 on which fixing means, generally indicated by reference numeral 402 is provided for mounting a display member on the flag stick 12. In the embodiment shown, the fixing means 402 is in the form of a collar 38 which is secured to the flag-stick 12. This permits a display member in the form of a sleeve 30 and a cover 32 to be mounted on the flag-stick in the manner described above. It will be appreciated, however, that the fixing means 402 could take any form and could for example be integral with the flag-stick 12.

In a further embodiment of the invention the display member may be integral with the flag-stick and may be used with or without the cover.

Reference is now made to FIG. 4 of the drawings in which reference numeral 110 refers generally to another golf hole marker assembly in accordance with the invention. The assembly 110 includes a flag-pole 112 on which a flag 114 is mounted.

The flag-pole 112 has an operatively lower end 112.1 and an operatively upper end 112.2. A ferrule 116 is mounted on the lower end of the flag-pole 112 and is receivable in a complementary socket in a cup 118 which is countersunk in a hole 120 in the ground, typically in a green, such that the flag pole 112 extends vertically upwardly therefrom.

The flag-pole 112 includes three sections or portions, namely, an elongate lower end portion 122, an elongate adjacent or intermediate portion 124 and an elongate upper portion 126.

In the embodiment shown, the adjacent portion 124 is circular cylindrical in shape and the lower end portion 122 and upper portion 126 are connected to and protrude from opposed ends of the adjacent portion 124. Further, the adjacent portion 124 has a diameter which is greater than the diameters of the lower end portion 122 and the upper portion 126.

As can clearly be seen in the drawing, when the ferrule 116 is positioned in the complementary socket in the cup 118, a part B of the lower end portion 122 is positioned below the surface 128 of the green. The length of the part B of the lower end portion 122 naturally depends on the depth to which the cup 118 is countersunk into the hole 120 and may vary accordingly.

The adjacent portion 124 forms a display member and defines an external display surface 130 on which matter, e.g. advertising, such as logos, company names, brand names and/or slogans can be or is displayed.

The flag 114 is mounted on the upper portion 126 in a conventional fashion.

The adjacent portion or display member 124 is connected to the lower end portion 122 and the upper portion 126. In one embodiment the display member is fixed to the lower end portion 122 and the upper portion 126. In a preferred embodiment shown in the drawings, the member 124 is disconnectably connected to the portions 122, 124 by means of collars 132. It will be appreciated that any suitable connecting arrangement for connecting the portions 122, 124, 126 together may be used. Hence, when it is desired to change the matter displayed on the display surface 130, the adjacent portion 124 can be disconnected from the portions 122, 126 and replaced with a new adjacent portion 124 on which the new matter to be displayed appears.

The matter being displayed can be applied directly to the surface of the display member, e.g. by being painted. Instead, the matter can be provided on a sticker which is secured adhesively to the member 124.

In order to avoid possibly interfering with a ball rolling into the hole 120, the lower end of the adjacent portion 124 is positioned above the part B by a distance X. The distance X will typically be at least 30 mm and more likely of the order of 0.6 m as explained above. Hence, the length of the lower end portion 22 will be X plus B.

It will be appreciated that the dimensions of the flag-stick 10 can vary. However, the Inventor believes that an adjacent portion 24 having a length L of about 1.4 m and a diameter of between 25 mm and 100 mm, typically about 50 mm will work satisfactory.

Instead of being circular in cross-section, the adjacent portion may be multi-facetted, e.g. triangular or square in transverse cross-section, thereby defining a plurality of angularly spaced rectangular display surfaces.

Reference is now made to FIG. 5 of the drawings in which reference numeral 200 refers generally to yet another golf hole marker assembly in accordance with the invention. The assembly 200 is similar in construction to the assembly 10 and, unless otherwise indicated, the same reference numerals used above are used to designate similar parts.

The main difference between the assemblies 10, 200 is that whereas the assembly 10 is intended for use in marking the position of a hole on a golf course, the assembly 200 is intended for use on a practice putting or chipping green and as such is substantially shorter than the assembly 10.

In addition an upwardly concave bowl 60 is mounted on the pole 16 adjacent the lower end thereof. The bowl 60 is dimensioned such that it is snugly receivable in the cup 20 so that a ball rolling into the cup rests on the bowl 60. Further, a handle 62 is mounted to the upper end of the pole 16 to facilitate lifting of the pole out of the hole. It will be appreciated, that balls resting on the bowl 60 will then also be lifted out of the hole 22. The handle 62 is in the form of a disc on which a hole number can appear. However, it will be appreciated, that the handle can be in any suitable form or could be replaced by a flag.

It will be appreciated, that the dimensions of the assembly 200 can vary. However, the Inventor believes that an accessory 14 having a length L of about 550 mm with the cover 32 having a diameter D of about 50 mm will work satisfactorily.

In FIG. 6 of the drawings, reference numeral 300 refers generally to still another golf hole-marker assembly in accordance with the invention. The assembly 300 is similar in construction to the assembly 110 and, unless otherwise indicated, the same reference numerals used above are used to designate similar parts.

Once again, whereas the assembly 110 is intended for use on a golf course, the assembly 300 is intended for use on a practice putting or chipping green and has dimensions similar to those of the assembly 200.

If desired the components of the accessory and/or the assembly can be provided in kit form.

The Inventor believes that a golf hole marker assembly 10, 110, 200, 300 in accordance with the invention, will provide advertisers with display surfaces on which advertising material can be displayed in a highly visible location. Further, by virtue of the fact that an accessory for a hole marker, in accordance with the invention, is readily mountable on a conventional flag-stick the flag-sticks can be modified relatively easily and in a cost effective manner.

1. An accessory for a golf hole marker which includes a display member which defines at least one outwardly directed display surface on which matter to be displayed is provided or is receivable, the display member begin removably mountable on a pole of a golf hole marker.

2. An accessory as claimed in claim 1, which includes retaining means for retaining the display member releasably in position.

3. An accessory as claimed in claim 1, in which the display member is in the form of a sleeve which is receivable over a pole of a golf hole marker such that at least a lower end portion of the pole protrudes from the sleeve.

4. An accessory as claimed in claim 3, in which the sleeve is circular in transverse cross-section.

5. An accessory as claimed in claim 3, in which the sleeve includes a plurality of angularly spaced planar display surfaces.

6. An accessory as claimed in claim 5, in which the sleeve is triangular in transverse cross-section and has three angularly spaced rectangular display surfaces.

7. An accessory as claimed in claim 1, which has a length of at least 500 mm.

8. An accessory as claimed in claim 1, which has a width of not greater than 10 cm.

9. An accessory as claimed in claim 8, which has a width of not greater than 51 mm.

10. A golf hole marker assembly which includes:
a pole having a lower end which is removably receivable in a cup countersunk into a hole in the ground; and
a display member dismountably mounted on the pole and defining at least one outwardly directed display surface on which matter to be displayed is provided or is receivable.

11. A golf hole marker assembly as claimed in claim 10, which includes a cover, at least part of which is transparent, covering the display member such that the display surface or matter displayed thereon is visible through the cover.

12. A golf hole marker assembly which includes:
a pole having a lower end which is removably receivable in a cup countersunk into a hole in the ground; and
an accessory as claimed in claim 1, mounted on the pole.

13. A golf hole marker assembly as claimed in claim 12, in which a lower end of the accessory is spaced longitudinally from the lower end of the pole by a distance which is greater than B, where B is the length of the pole which will be below the surface of the ground when the pole is positioned in a said cup.

14. A golf hole marker assembly as claimed in claim 13, in which the lower end of the accessory is spaced longitudinally from the lower end of the pole by a distance of at least B+30 mm, so that the accessory will not interfere with a ball rolling into the hole when the lower end of the pole is positioned therein.

15. A golf hole marker assembly as claimed in claim 14, in which the lower end of the accessory is spaced longitudinally from the lower end of the pole by a distance of at least B+610 mm.

16. A golf hole marker assembly which includes
a pole having a lower end which is removably receivable in a cup countersunk into a hole in the ground; and
a rigid display member mounted on the pole and defining at least one outwardly directed display surface on which matter to be displayed is provided or is receivable.

17. A golf hole marker assembly which includes
a pole having a lower end which is removably receivable in a cup countersunk into a hole in the ground; and
a display member which is secured adhesively to the pole.

18. A golf hole marker assembly as claimed in claim 17 in which the display member is in the form of a sticker.

19. A golf hole marker assembly as claimed in claim 17, in which the display member has a length which is equal to or greater than 40% of the length of the pole.

20. A golf hole marker assembly as claimed in claim 17, in which the display member has a length which is equal to or greater than 50% of the length of the pole.

21. A golf hole marker assembly as claimed in claim 17, in which the display member has a length which is equal to or greater than 60% of the length of the pole.

22. A golf hole marker assembly as claimed in claim 17, in which the display member has a length which is equal to or greater than 75% of the length of the pole.

23. A golf hole marker assembly as claimed in claim 16, which includes a cover, at least part of which is transparent, covering at least part of the display member.

24. A display member for an accessory as claimed in claim 1.

25. A display member for a golf hole marker assembly as claimed in claim 10.

26. A display member for a golf hole marker assembly as claimed in claim 12.

27. A display member for a golf hole marker assembly as claimed in claim 16.

28. A display member for a golf hole marker assembly as claimed in claim 17.

29. A golf hole marker assembly kit which includes
a pole having a lower end which is removably receivable in a cup countersunk into a hole in the ground; and
a display member defining at least one outwardly directed display surface which is mountable on the pole, wherein matter to be displayed is provided or is receivable on said at least one display surface.

30. A golf hole marker assembly kit as claimed in claim 29, which includes a cover mounted or mountable over at least part of the display surface.
